(19) United States
(12) Patent Application Publication
(10) Pub. No.: US 2015/0035994 A1
(43) Pub. Date: Feb. 5, 2015

(54) PORTABLE COMMUNICATION APPARATUS, METHOD OF TESTING THE SAME, DISPLAY APPARATUS, AND COMPUTER-READABLE RECORDING MEDIUM

(71) Applicant: SAMSUNG ELECTRONICS CO., LTD., Suwon-si (KR)

(72) Inventors: Ho-yong SON, Suwon (KR); Hong-jae KIM, Suwon (KR)

(73) Assignee: SAMSUNG ELECTRONICS CO., LTD., Suwon (KR)

(21) Appl. No.: 14/301,705

(22) Filed: Jun. 11, 2014

(30) Foreign Application Priority Data
Jul. 31, 2013 (KR) 10-2013-0091085

(51) Int. Cl. H04N 17/00

(52) U.S. Cl. CPC H04N 17/004; H04N 2017/006
USPC 348/189

(57) ABSTRACT

A portable communication apparatus is provided. The portable communication apparatus includes: a camera module configured to capture a plurality of test images that are sequentially output from a display apparatus; a microphone module configured to record a test voice that is output from the display apparatus; a communication interface unit configured to communicate with the display apparatus; and a controller configured to control the communication interface unit to calculate an output time difference between the plurality of test images and the test voice to test a synchronization state of the display apparatus and transmit the test result to the display apparatus.

### CROSS-REFERENCE TO RELATED APPLICATIONS

This application claims priority benefit under 35 U.S.C. §119 from Korean Patent Application No. 10-2013-0091085, filed on Jul. 31, 2013, in the Korean Intellectual Property Office, the disclosure of which is incorporated herein by reference in its entirety.

### BACKGROUND

1. Field

The present general inventive concept generally relates to providing a portable communication apparatus, a method of testing the same, a display apparatus, and computer-readable recording medium and more particularly, to providing a portable communication apparatus that tests a synchronization state of a display apparatus, a method of testing the same, and the display apparatus.

2. Description of the Related Art

A display apparatus performs signal-processing for decoding a video signal and an audio signal and synchronizing the decoded video and audio signal. The display apparatus outputs the video and audio signal that have been signal-processed, so that a user simultaneously recognize an image corresponding to the video signal and a voice corresponding to the audio signal.

In general, since processing for the video signal requires a larger amount of time than processing for the audio signal, the audio signal is delayed to synchronize with the video signal. Here, a delay value of the audio signal is preset by a manufacturer or a producer in consideration of a time difference between the video and audio signals that have been signal-processed by the display apparatus.

However, a synchronization state between the video and audio signals may become unstable according to a use environment of the display apparatus.

Also, although the display apparatus simultaneously outputs the video and audio signals, transmission of the audio signal is delayed according to a distance between the display apparatus and the user. Therefore, the user feels that the video and audio signals do not synchronize with each other. In particular, the display apparatus has been increasingly used in a public place (for example, a station, a terminal, or the like). Also, if a large format display (LFD) is used to provide advertisement, sports game, or the like in a public place, the distance between the display apparatus and the user becomes longer. Therefore, the user feels that the video and audio signals do not synchronize with each other and thus feels great inconvenience.

### SUMMARY

Additional aspects and/or advantages will be set forth in part in the description which follows and, in part, will be apparent from the description, or may be learned by practice of the invention.

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a portable communication apparatus that tests a synchronization state of a display apparatus and transmits the test result to the display apparatus, and a method of testing the same.

The exemplary embodiments also provide a display apparatus that outputs a plurality of test images and one test voice in a test mode and sets a delay value of an audio signal by using a test result provided from a portable communication apparatus.

According to an aspect of the exemplary embodiments, there is provided a portable communication apparatus including: a camera module configured to capture a plurality of test images that are sequentially output from a display apparatus; a microphone module configured to record a test voice that is output from the display apparatus; a communication interface unit configured to communicate with the display apparatus; and a controller configured to control the communication interface unit to calculate an output time difference between the plurality of test images and the test voice to test a synchronization state of the display apparatus and transmit the test result to the display apparatus.

The controller may perform the test based on output rule information between the plurality of test images and the test voice.

The output rule information may be output information about one of the plurality of test images that is set to be compared with a synchronization state of the test voice.

When a user command to test a synchronization state of the display apparatus is input, the controller may control the communication interface unit to start communicating with the display apparatus.

When the output rule information is received from the display apparatus through the communication interface unit after communicating with the display apparatus starts, the controller may store the output rule information in a storage unit.

The portable communication apparatus may further include: the storage unit configured to store a plurality of pieces of output rule information that are separately set according to manufacturers or product models.

The portable communication apparatus may further include: a display unit. When communicating with the display apparatus starts, the controller may control the display unit to display a selection screen for selecting a manufacturer or a product model of the display apparatus, read output rule information corresponding to the manufacturer or the product model selected through the selection screen from the storage unit, and calculate the output time difference based on the read output rule information.

The controller may perform subtraction between a first time when one of the plurality of test images set by the output rule information is output and a second time when the test voice is output, to calculate the output time difference.

According to another aspect of the exemplary embodiments, there is provided a display apparatus connected to a portable communication apparatus. The display apparatus may include: a signal processor configured to process a video signal and an audio signal; a first output unit configured to output a plurality of test images; a second output unit configured to output a test voice; a communication interface unit configured to communicate with the portable communication apparatus; and a controller configured to control the second output unit to output the test voice at a time when one of the plurality of test images is output and, if a test result including an output time difference is received from the portable communication apparatus through the communication interface unit, set a delay value of the audio signal by using the output time difference. The signal processor may delay the processed audio signal by the set delay value of the audio signal to synchronize the video and audio signals.

The signal processor may include: a first signal processor configured to process the video signal; a second signal processor configured to process the audio signal; and a delayer configured to delay an output of the processed audio signal by using the delay value of the audio signal.

When the communication interface unit starts communicating with the portable communication apparatus, the controller may operate in a test mode and control the communication interface unit to transmit pre-stored output rule information indicating output information about one of the plurality of test images, which is set to be compared with a synchronization state of the test voice, to the portable communication apparatus.

According to another aspect of the exemplary embodiments, there is provided a testing method of a portable communication apparatus that communicates with a display apparatus. The testing method may include: capturing a plurality of test images that are sequentially output from the display apparatus; recording a test voice that is output from the display apparatus; calculating an output time difference between the plurality of test images and the test voice to test a synchronization state of the display apparatus; and transmitting the test result including the output time difference to the display apparatus.

The testing of the synchronization state of the display apparatus may include: performing the test based on output rule information between the plurality of test images and the test voice.

The output rule information may be output information about one of the plurality of test images that is set to be compared with a synchronization state of the test voice.

The testing method may further include: when a user command to test the synchronization state of the display apparatus is input, starting communicating with the display apparatus.

The testing method may further include: when communicating with the display apparatus starts, receiving the output rule information from the display apparatus.

The testing method may further include: when communicating with the display apparatus starts, displaying a selection screen for selecting manufacturer or a product model information of the display apparatus; reading output rule information corresponding to manufacturer or product model information selected through the selection screen, from a plurality of pieces of output rule information that are separately set according to pre-stored manufacturers or product models; and calculating the output time difference based on the read output rule information.

The testing of the synchronization state of the display apparatus may include: performing subtraction between a first time when one of the plurality of test images set by the output rule information is output and a second time when the test voice is output, to calculate the output time difference.

### BRIEF DESCRIPTION OF THE DRAWINGS

These and/or other aspects and advantages will become apparent and more readily appreciated from the following description of the embodiments, taken in conjunction with the accompanying drawings of which:

The above and/or other aspects will be more apparent by describing certain exemplary embodiments with reference to the accompanying drawings, in which:

FIG. 1 is a view illustrating a system that tests a synchronization state of a display apparatus, according to an exemplary embodiment of the present general inventive concept;

FIG. 2 is a block diagram illustrating a structure of a portable communication apparatus according to an exemplary embodiment of the present general inventive concept;

FIG. 3 is a block diagram illustrating a structure of a display apparatus according to an exemplary embodiment of the present general inventive concept;

FIG. 4 is a view illustrating output rule information according to an exemplary embodiment of the present general inventive concept;

FIG. 5 is a view illustrating a screen for selecting a display apparatus according to an exemplary embodiment of the present general inventive concept;

FIG. 6 is a flowchart illustrating a method of testing a portable communication apparatus according to an exemplary embodiment of the present general inventive concept; and

FIG. 7 is a flowchart illustrating a method of setting a delay value of an audio signal of a display apparatus according to an exemplary embodiment of the present general inventive concept.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

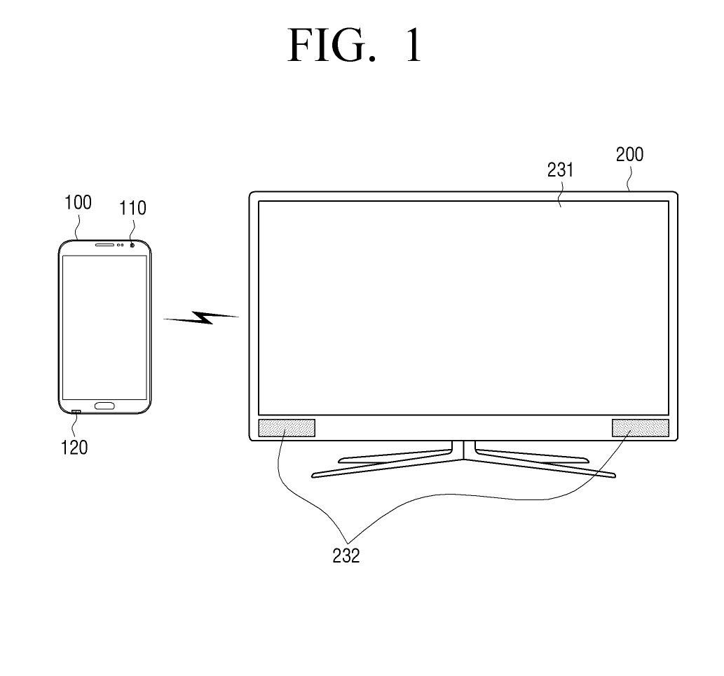

FIG. 1 is a view illustrating a system that tests a synchronization state of a display apparatus, according to an exemplary embodiment of the present general inventive concept. Referring to FIG. 1, the system includes a portable communication apparatus 100 and a display apparatus 200.

The portable communication apparatus 100 may be a portable phone, a smart phone, a tablet PC, or the like. However, the present general inventive concept is not limited thereto, and the portable communication apparatus 100 may be another type of apparatus that performs communication and has an image capturing function and a voice recording function.

The display apparatus 200 may be a TV, a computer monitor, or the like and may be another type of apparatus having a display function.

The portable communication apparatus 100 includes a camera module 110 that may be installed in a front part thereof and a microphone module 120 that may be installed in a side thereof.

The display apparatus 200 includes a first output unit 231 that outputs an image and a second output unit 232 that outputs a voice. Here, the first output unit 231 may be a display screen, and the second output unit 232 may be a speaker.

If a user command to test a synchronization state of the display apparatus 200 is input, the portable communication apparatus 100 may start communicating with the display apparatus 200.

If the portable communication apparatus 100 and the display apparatus 200 communicate with each other, the display apparatus 200 may control the first output unit 231 to output a plurality of test images and control the second output unit 232 to output one test voice.

The plurality of test images and a test voice may be output according to output rule information. Here, the output rule information refers to output information about one of the plurality of test images that is set to be compared with a synchronization state of the test voice. In other words, if the plurality of test images are sequentially displayed, the output rule information may indicate whether to output the test voice when which one of the plurality of test images is output.

As described above, when the display apparatus 200 outputs the plurality of test images and the test voice, the portable communication apparatus 100 may control the camera module 110 to capture the plurality of test images that are sequentially output from the display apparatus 200 and may control the microphone module 120 to record the test voice output from the display apparatus 200.

The portable communication apparatus 100 may calculate or measure an output time difference between one of the plurality of test images and the test voice based on the output rule information to test the synchronization state of the display apparatus 200.

The portable communication apparatus 100 may know the output rule information about the plurality of test images and the test voice that are output from the display apparatus 200. In detail, if the portable communication apparatus 100 and the display apparatus 200 starts communicating with each other, the display apparatus 200 may transmit the output rule information thereof to the portable communication apparatus 100.

Alternatively, the portable communication apparatus 100 may pre-store a plurality of pieces of output rule information that are separately set according to manufacturers or product models of various types of display apparatuses.

Therefore, the portable communication apparatus 100 may perform subtraction between a first time when one of the pluralities of test images set by the output rule information of the display apparatus 200 is output and a second time when the test voice is output, by using the output rule information to calculate an output time difference. As a result, the output time difference may be an output time difference between an image and a voice that are output from the display apparatus 200.

The portable communication apparatus 100 transmits the calculated output time difference to the display apparatus 200. The display apparatus 200 that has received the output time difference sets the output time difference as a delay value of an audio signal thereof. In other words, if a preset delay value of an audio signal exists, the display apparatus 200 may update the delay value of the audio signal by using the received output time difference.

According to the system of FIG. 1, the portable communication apparatus 100 may test the synchronization state of the display apparatus 200 to accurately determine the synchronization state of the display apparatus 200.

As the portable communication apparatus 100 performs the above-described test, the user performs a test by using the portable communication apparatus 100 in a position where the user views the display apparatus 200. Therefore, a desynchronization problem, occurring between an image and a voice according to a distance between the display apparatus 200 and the user, may be solved.

The display apparatus 200 may receive a test result from the portable communication apparatus 100 and set the delay value of the audio signal by using the output time difference included in the test result in order to accurately synchronize and output the image and the voice.

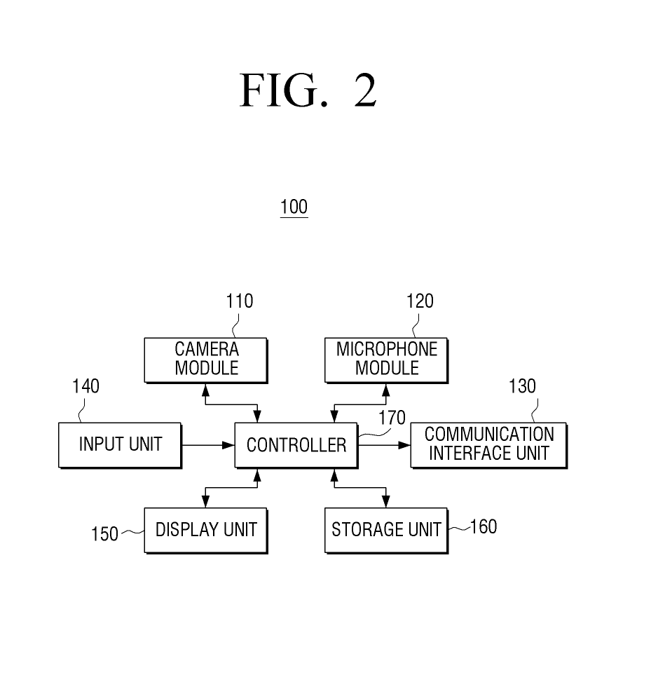

FIG. 2 is a block diagram illustrating a structure of the portable communication apparatus 100, according to an exemplary embodiment of the present general inventive concept. Referring to FIG. 2, the portable communication apparatus 100 may include the camera module 110, the microphone module 120, a communication interface unit 130, an input unit 140, a display unit 150, a storage unit 160, and a controller 170.

The camera module 110 captures an image.

The microphone module 120 records a voice.

The communication interface unit 130 may be a wire/wireless communication module that is connected to communication cable, or communicate with an external apparatus or access a server or a website by using 3G, WiFi, or Bluetooth. However, a communication method of the communication interface unit 130 is not limited thereto.

The input unit 140 receives a user command and may be a keypad, a touch screen, or the like.

The display unit 150 displays the image.

The storage unit 160 stores a program, data, or the like necessary for operating the portable communication apparatus 100. The storage unit 160 may store an application, a program, data, or the like that is received or downloaded from an external apparatus, a server, a website, or the like.

The controller 170 controls an operation of the portable communication apparatus 100.

In detail, if a user command to test a synchronization state of the display apparatus 200 is input through the input unit 140, the controller 170 may control the communication interface unit 130 to start communicating with the display apparatus 200.

For example, if the user feels that the image and the voice do not synchronize with each other when viewing the image and the voice by using the display apparatus 200, the user may input a command that is to test the synchronization state of the display apparatus 200. The user command may include identification information (an apparatus number or an apparatus model) of the display apparatus 200, etc.

If communicating with the display apparatus 200 starts, the controller 170 tests the synchronization state of the display apparatus 200. In detail, the controller 170 may control the camera module 110 to capture a plurality of test images that are sequentially output from the display apparatus 200 and control the microphone module 120 to record a test voice that is output from the display apparatus 200. The controller 170 also performs a test based on output rule information between the plurality of test images and the test voice. The test is to check a synchronization state between an image (a video signal) and a voice (an audio signal) that are output from the display apparatus 200. A delay value of the audio signal of the display apparatus 200 may be transmitted, as a result of the test, to the display apparatus 200.

In detail, the controller 170 may perform the test based on the output rule information between the plurality of test images and the test voice.

After the portable communication apparatus 100 and the display apparatus 200 start communicating with each other, a request for the output rule information may be transmitted from the portable communication apparatus 100 to the display apparatus 200, and a response to the request may be received. In this case, the received output rule information may be stored in the storage unit 160.

Alternatively, a plurality of pieces of output rule information that are separately set according to manufacturers or product models of various types of display apparatuses may be stored in the storage unit 160. In this case, the controller 170 may control the display unit 150 to display a selection screen that is to select a manufacturer or a product model of the display apparatus 200 and read output rule information corresponding to the selected manufacturer or product model from the storage unit 160. The controller 170 may perform a test based on the read output rule information.

The output rule information refers to output information about one of a plurality of test images that is set to be compared with a synchronization state of a test voice. Therefore, the controller 170 may calculate an output time difference between the plurality of test images and the test voice based on the output rule information. The controller 170 may perform subtraction between a first time when one of the pluralities of test images set by the output rule information is output and a second time when the test voice is output, to calculate the output time difference.

If the output time difference is 0 or less than a predetermined value, the controller 170 may determine that an image and a voice output from the display apparatus synchronize with each other. In this case, the controller 170 may control the communication interface unit 130 to transmit a test result of the output time difference to the display apparatus 200. The test result may be a signal for indicating that the output time difference is 0, and a synchronization state is normal.

If the output time difference is not 0 or larger than a predetermined value, the controller 170 may determine that the image and the voice output from the display apparatus 200 do not synchronize with each other. In this case, the controller 170 may control the communication interface unit 130 to transmit the test result of the output time difference to the display apparatus 200. The test result may be a signal for indicating that a value of the output time difference and the synchronization state are abnormal.

If the communication interface unit 130 stops communicating with the display apparatus 200, the controller 170 may end a test operation.

In the present exemplary embodiment, an output time difference is calculated one time by using a plurality of test images and one test voice. However, if the display apparatus 200 repeatedly outputs a plurality of test images and one test voice as one set two or more times, the portable communication apparatus 100 may also repeatedly calculate an output time difference two or more times. If an output time difference as described above is calculated two or more times, an average value may be calculated. However, it is not limited thereto.

The portable communication apparatus 100 of FIG. 2 may accurately test a synchronization state of the display apparatus 200 by using a plurality of test images and a test voice that are output from the display apparatus 200.

The portable communication apparatus 100 has a portable size, performs wireless communication, and performs the above-described test in a position where the user actually views the display apparatus 200. Therefore, although the synchronization state of the display apparatus 200 is abnormal due to a distance between the display apparatus 200 and the user, the distance may be reflected to calculate an output time difference.

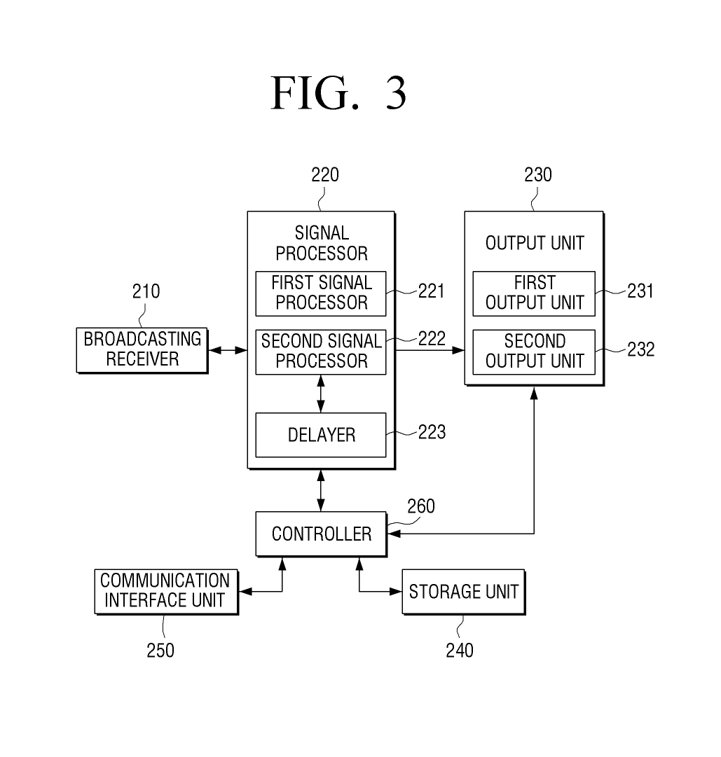

FIG. 3 is a block diagram illustrating a structure of the display apparatus 200, according to an exemplary embodiment of the present general inventive concept. Referring to FIG. 3, the display apparatus 200 includes a broadcasting receiver 210, a signal processor 220, an output unit 230, a storage unit 240, a communication interface unit 250, and a controller 260.

The broadcasting receiver 210 may receive a broadcasting signal that includes a video signal and an audio signal. The broadcasting receiver 210 may be a tuner.

The signal processor 220 includes a first signal processor 221, a second signal processor 222, and a delayer 223 that are to decode and synchronize the video and audio signals. Although not shown in FIG. 3, the signal processor 220 may further include an element that separates the video and audio signals from the broadcasting signal.

The first signal processor 221 processes the video signal, and the second signal processor 222 processes the audio signal.

The delayer 223 delays an output of the audio signal that is processed by the second signal processor 222. In this case, the delayer 223 may delay the output of the audio signal by a delay value of a preset audio signal.

The output unit 230 includes first and second output units 231 and 232. In the present exemplary embodiment, the first output unit 231 may output the video signal processed by the first signal processor 221 as an image, and the second output unit 232j may output the audio signal that is delayed by a preset delay value and then output.

When the display apparatus 200 operates in a test mode, the first output unit 231 may sequentially output a plurality of test images, and the second output unit 232 may output a test voice.

The storage unit 240 stores a program or data necessary for an operation of the display apparatus 200. The storage unit 240 may store the plurality of test images and the test voice that are to be used in the test mode, and output rule information of the plurality of test images and the test voice.

The communication interface unit 250 may communicate with the portable communication apparatus 100.

The controller 260 controls an overall operation of the display apparatus 200.

If it is sensed that communicating with the portable communication apparatus 100 through the communication interface unit 250 starts, the controller 260 may change a general mode for outputting the broadcasting signal into the test mode. The test mode may be a mode in which the plurality of test images and the test voice are output so as to allow the portable communication apparatus 10 to test a synchronization state between an image and a voice output from the display apparatus 200.

If the general mode is changed into the test mode, the controller 260 may read the output rule information from the storage unit 240 and control the communication interface unit 250 to transmit the output rule information to the portable communication apparatus 100. This operation may be performed if a request for the output rule information is received from the portable communication apparatus 100.

The controller 260 may control the first output unit 231 to sequentially output the plurality of test images and control the second output unit 232 to output the test voice at a time when one of the plurality of test images is output based on the output rule information.

The controller 260 may control the first and second output units 231 and 232 to output the plurality of test images and the test voice as one set one time or repeatedly output the plurality of test images and the test voice as one set two or more times. This is to improve accuracy of a test performed by the portable communication apparatus 100.

If a test result including an output time difference is received from the portable communication apparatus 100 after the plurality of test images and the test voice are output, the controller 260 may set a delay value of the audio signal by using the output time difference.

If the output time difference is 0 or less than a predetermined value, and a synchronization is normal according to the test result, the controller 260 may maintain the delay value of the audio signal that is preset in the delayer 223.

If the output time difference is not 0 or larger than a predetermined value, and the synchronization state is abnormal, the controller 260 may set a delay value of the audio signal of the delayer 223 by using the output time difference. In other words, the preset delay value of the audio signal of the delayer 223 may be updated as the received output time difference. For example, if the preset delay value of the audio signal is 50 ms, and the received output time difference is 500 ms, the preset delay value of the audio signal may be updated to 500 ms.

The display apparatus 200 of FIG. 3 may receive the test result from the portable communication apparatus 100 and set the delay value of the audio signal by using the output time difference included in the test result in order to accurately synchronize and output an image and a voice.

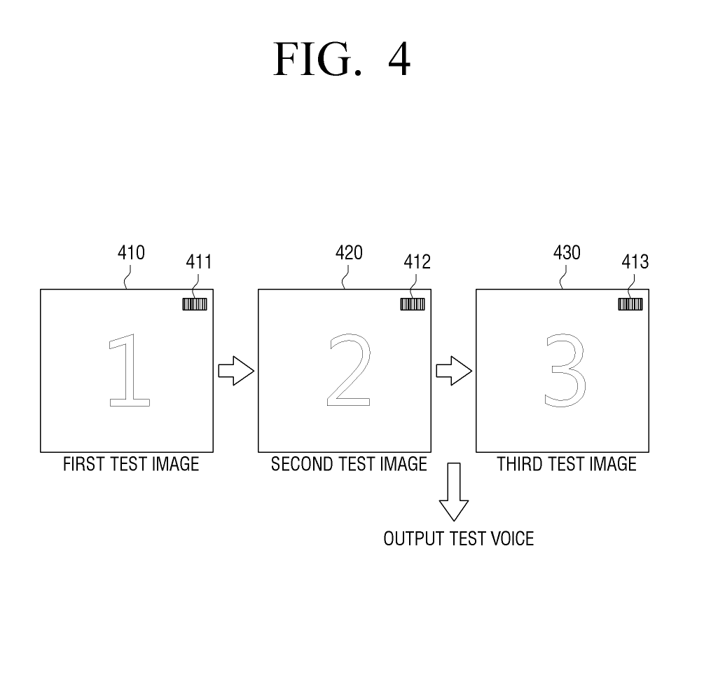

FIG. 4 is a view illustrating output rule information according to an exemplary embodiment of the present general inventive concept.

As shown in FIG. 4, when a process of performing a test for checking a synchronization state of the display apparatus 200 is performed, the display apparatus 200 outputs first, second, and third test images 410, 420, and 430, and a test voice according to output rule information

The output rule information refers to output information about one of the first, second, and third test images 410, 420, and 430 that is set to be compared with a synchronization state of the test voice. In other words, the output rule information may be information indicating which one of the first, second, and third test images 410, 420, and 430 is to be output simultaneously with the test voice.

Referring to FIG. 4, the output rule information according to the present exemplary embodiment refers to information indicating that the third test image 430 of the first, second, and third test images 410, 420, and 430 is output simultaneously with the test voice.

If the display apparatus 200 outputs the first, second, and third test images 410, 420, and 420, and the test voice according to the output rule information, the portable communication apparatus 100 captures the first, second, and third test images 410, 420, and 430 and records the test voice.

The portable communication apparatus 100 may perform subtraction between a first time when the third test image 430 of the first, second, and third test images 410, 420, and 430 is output and a second time when the test voice is output, based on the output rule information, in order to calculate an output time difference.

Numbers corresponding to output orders may be respectively written in the first, second, and third test images 410, 420, and 430 so as to identify whether images displayed on the display apparatus 200 are the first test image 410, the second test image 420, or the third test image 430.

Alternatively, the first, second, and third test images 410, 420, and 430 may include different identification markers 411, 412, and 413 in a predetermined position. The identification markers 411, 412, and 413 may be barcodes or QR codes.

The first, second, and third test images 410, 420, and 430 may have different colors (for example, red, green, and yellow) or different patterns (for example, a vertical line, a horizontal line, a diagonal line, etc.).

As described above, the first, second, and third test images 410, 420, and 430 may be identified by identification elements such as numbers, identification markers, colors, patterns, or the like. Therefore, even if the portable communication apparatus 100 misses capturing of the first test image 410, the third test image 430 that is to be compared with a synchronization state of the test voice may be accurately identified.

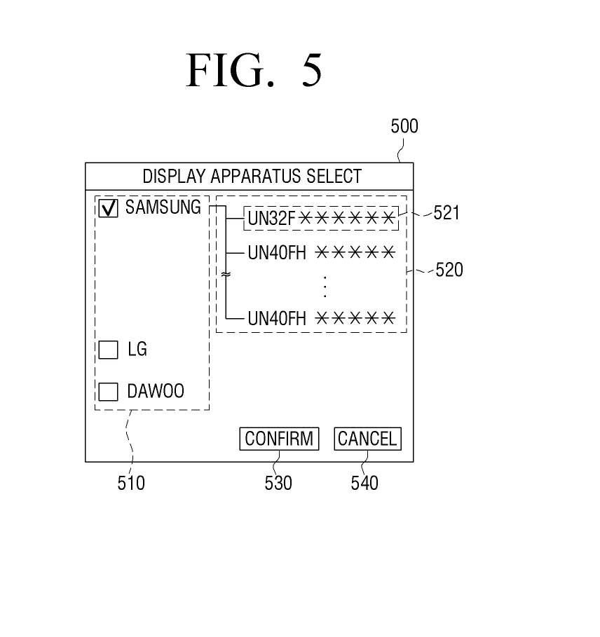

FIG. 5 is a view illustrating a screen for selecting a display apparatus according to an exemplary embodiment of the present general inventive concept.

The portable communication apparatus 100 may store output rule information between a plurality of test images and a test voice that are output from the display apparatus 200, in order to perform a test.

In particular, the portable communication apparatus 100 may store a plurality of pieces of output rule information that are separately set according to manufacturers and/or product models of various types of display apparatuses, so that a user tests the display apparatus 200 anytime anywhere regardless of a type of the display apparatus 200 by using the portable communication apparatus 100. Therefore, the portable communication apparatus may select manufacturer and/or product model information of the display apparatus 200 in order to use one of the plurality of pieces of output rule information corresponding to the display apparatus 200.

If communicating with the display apparatus 200 starts, the portable communication apparatus 100 may display a selection screen 500, which is to select the manufacturer and/or product model information of the display apparatus 200, in a pop-up menu form.

Referring to FIG. 5, the selections screen 500 includes a manufacturer list 510 and a product model list 520. If the user selects “Samsung” on the manufacturer list 510, the product model list 520 may be displayed.

The product model list 520 includes product models of display apparatus that are manufactured by “Samsung”. If the user selects mode 521 “UN32F******” on the product model list 520 and presses a confirm button 530, the portable communication apparatus 100 may read output rule information corresponding to the mode 521 “UN32F******” of “Samsung” and use the read output rule information for a test.

Alternatively, if the user presses a cancel button 540 on the selection screen 500, the portable communication apparatus 100 may remove the selection screen 500 on a screen.

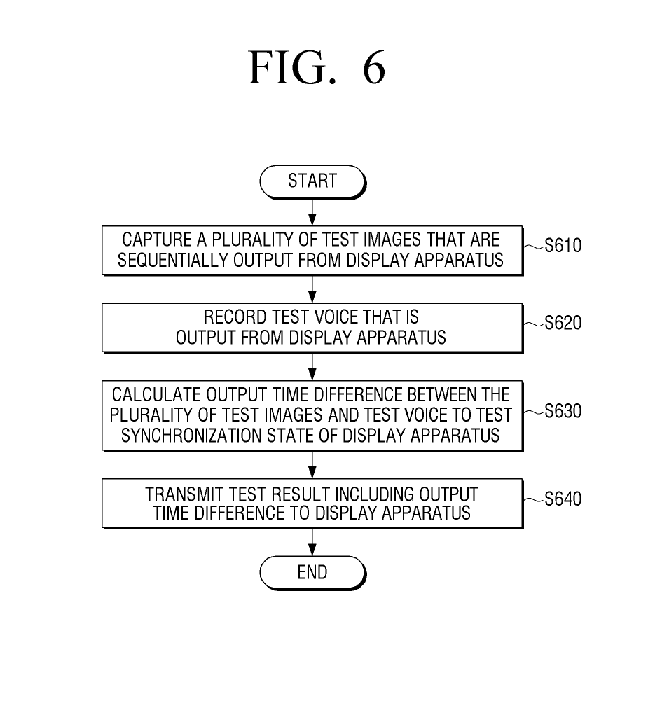

FIG. 6 is a flowchart illustrating a testing method of a portable communication apparatus according to an exemplary embodiment of the present general inventive concept. The portable communication apparatus 100 according to the present exemplary embodiment may be connected to the display apparatus 200 to test a synchronization state between an image and a voice that are output from the display apparatus 200.

If communicating with the display apparatus 200 starts, the portable communication apparatus 100 captures a plurality of test images that are sequentially output from the display apparatus 200, in operation S610. The portable communication apparatus 100 records a test voice that is output from the display apparatus 200 in operation S620.

In operation S630, the portable communication apparatus 100 calculates an output time difference between the plurality of test images and the test voice to test a synchronization state of the display apparatus 200. Here, the portable communication apparatus 100 may calculate an output time difference between one of the pluralities of test images set to be compared with a synchronization state of the test image and the test voice, based on output rule information.

In operation S640, the portable communication apparatus 100 transmits a test result which may include the output time difference to the display apparatus 200. Therefore, the portable communication apparatus 100 may delay an audio signal, which is output in a voice form from the display apparatus 200, by the output time difference.

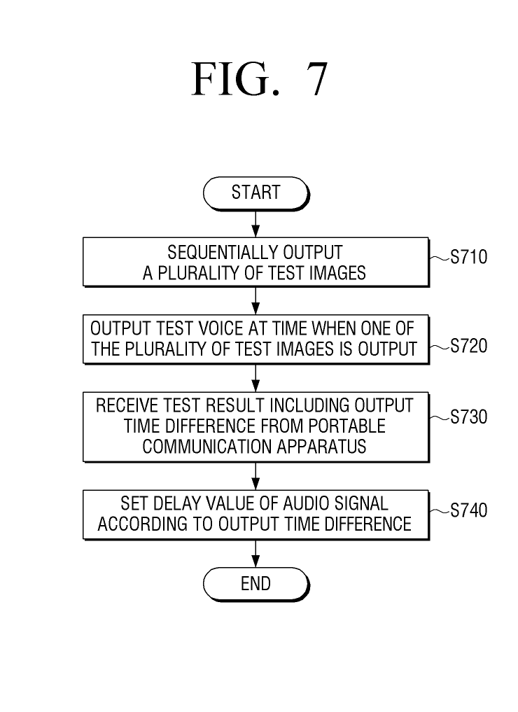

FIG. 7 is a flowchart illustrating a method of setting a delay value of an audio signal of a display apparatus according to an exemplary embodiment of the present general inventive concept.

If the display apparatus 200 is connected to the portable communication apparatus 100, the display apparatus 200 operates in a test mode to sequentially output a plurality of test images in the test mode in operation S710.

In operation S720, the display apparatus 200 outputs a test voice at a time when one of the plurality of test images is output, based on output rule information.

In operation S730, the display apparatus 200 receives a test result which may include an output time difference from the portable communication apparatus 100.

In operation S740, the display apparatus 200 sets a delay value of an audio signal according to the test result, for example, using the time difference. Here, the output time difference refers to an output time difference between an image and a voice that are output from the display apparatus 200. Therefore, the display apparatus 200 may delay the audio signal by using the output time difference to accurately synchronize and output the image and the voice.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like.. Examples of program instructions include both machine code, such as produced by a compiler, and files including higher level code that may be executed by the computer using an interpreter. The described hardware devices may be configured to act as one or more software modules in order to perform the operations of the above-described example embodiments, or vice versa.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A portable communication apparatus, comprising:
a camera module configured to capture a plurality of test images that are sequentially output from a display apparatus;
a microphone module configured to record a test voice that is output from the display apparatus;
a communication interface unit configured to communicate with the display apparatus; and
a controller configured to control the communication interface unit to calculate an output time difference between the plurality of test images and the test voice to test a synchronization state of the display apparatus and transmit the test result to the display apparatus.

2. The portable communication apparatus of claim 1, wherein the controller performs the control based on output rule information between the plurality of test images and the test voice.

3. The portable communication apparatus of claim 2, wherein the output rule information is output information about one of the plurality of test images that is set to be compared with a synchronization state of the test voice.

4. The portable communication apparatus of claim 2, wherein when a user command to test a synchronization state of the display apparatus is input, the controller controls the communication interface unit to start communicating with the display apparatus.

5. The portable communication apparatus of claim 4, wherein when the output rule information is received from the display apparatus through the communication interface unit after communicating with the display apparatus starts, the controller stores the output rule information in a storage unit.

6. The portable communication apparatus of claim 2, further comprising:
the storage unit configured to store a plurality of pieces of output rule information that are separately set according to one of manufacturers and product models.

7. The portable communication apparatus of claim 6, further comprising:
a display unit,
wherein when communicating with the display apparatus starts, the controller controls the display unit to display a selection screen for selecting one of the manufacturer and the product model of the display apparatus, reads output rule information corresponding to the one of the manufacturer and the product model selected through the selection screen from the storage unit, and calculates the output time difference based on the read output rule information.

8. The portable communication apparatus of claim 2, wherein the controller performs subtraction between a first time when one of the plurality of test images set by the output rule information is output and a second time when the test voice is output, to calculate the output time difference.

9. A display apparatus capable of communicating with a portable communication apparatus, the display apparatus comprising:
a signal processor configured to process a video signal and an audio signal;
a first output unit configured to output a plurality of test images;
a second output unit configured to output a test voice;
a communication interface unit configured to communicate with the portable communication apparatus; and
a controller configured to control the second output unit to output the test voice at a time when one of the plurality of test images is output and, if a test result comprising an output time difference is received from the portable communication apparatus through the communication interface unit, set a delay value of the audio signal by using the output time difference, wherein the signal processor delays the processed audio signal by the set delay value of the audio signal to synchronize the video and audio signals.

10. The display apparatus of claim 9, wherein the signal processor comprises:
a first signal processor configured to process the video signal;
a second signal processor configured to process the audio signal; and
a delayer configured to delay an output of the processed audio signal by using the delay value of the audio signal.

11. The display apparatus of claim 9, wherein when the communication interface unit starts communicating with the portable communication apparatus, the controller operates in a test mode and controls the communication interface unit to transmit pre-stored output rule information indicating output information about one of the plurality of test images, which is set to be compared with a synchronization state of the test voice, to the portable communication apparatus.

12. A testing method of a portable communication apparatus that communicates with a display apparatus, the testing method comprising:
capturing a plurality of test images that are output from the display apparatus;
recording a test voice that is output from the display apparatus;
calculating an output time difference between the plurality of test images and the test voice to test a synchronization state of the display apparatus; and
transmitting the test result to the display apparatus.

13. The testing method of claim 12, wherein the testing of the synchronization state of the display apparatus comprises:
performing the test based on output rule information between the plurality of test images and the test voice.

14. The testing method of claim 13, wherein the output rule information is output information about one of the plurality of test images that is set to be compared with a synchronization state of the test voice.

15. The testing method of claim 12, further comprising:
when a user command to test the synchronization state of the display apparatus is input, starting communicating with the display apparatus.

16. The testing method of claim 15, further comprising:
when communicating with the display apparatus starts, receiving the output rule information from the display apparatus.

17. The testing method of claim 15, further comprising:
when communicating with the display apparatus starts, displaying a selection screen for selecting one of a manufacturer and a product model information of the display apparatus;
reading output rule information corresponding to the one of the manufacturer and the product model information selected through the selection screen, from a plurality of pieces of output rule information that are separately set according to pre-stored manufacturers and product models; and
calculating the output time difference based on the read output rule information.

18. The testing method of claim 13, wherein the testing of the synchronization state of the display apparatus comprises:
performing subtraction between a first time when one of the plurality of test images set by the output rule information is output and a second time when the test voice is output, to calculate the output time difference.

19. The testing method of claim 12, wherein the result comprises the output time difference.

20. A non-transitory computer-readable recording medium having embodied thereon a program for executing the method of claim 12.
